(19) United States
(12) Patent Application Publication
(10) Pub. No.: US 2008/0090651 A1
(43) Pub. Date: Apr. 17, 2008

(54) GAMING SYSTEM AND METHOD HAVING MULTI-LEVEL MYSTERY TRIGGERED PROGRESSIVE AWARDS

(76) Inventor: Anthony J. Baerlocher, Reno, NV (US)

Correspondence Address: BELL, BOYD & LLOYD LLP, P.O. Box 1135, CHICAGO, IL, 60690, US

(21) Appl. No.: 11/548,587

(22) Filed: Oct. 11, 2006

(51) Int. Cl. G06F 19/00

(52) U.S. Cl. 463/27

(57) ABSTRACT

A gaming system including a central server linked to a plurality of gaming machines. The gaming system includes at least one and preferably a plurality of progressive awards wherein upon a suitable initiating event, a wager amount or value is randomly generated from at least one predetermined range of wager amounts or values. Upon a suitable triggering event, such as an accumulated wager pool incrementing to the randomly generated wager amount or value, a designated award, such as a progressive award, is provided to a player. In one such embodiment, upon the occurrence of the triggering event, an independent determination occurs regarding which one of the plurality of progressive awards will be provided to a player.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Gaming machines which provide players awards in primary or base games are well known. Gaming machines generally require the player to place or make a wager to activate the primary or base game. In many of these gaming machines, the award is based on the player obtaining a winning symbol or symbol combination and on the amount of the wager (e.g., the higher the wager, the higher the award). Symbols or symbol combinations which are less likely to occur usually provide higher awards.

In such known gaming machines, the amount of the wager made on the base game by the player may vary. For instance, the gaming machine may enable the player to wager a minimum number of credits, such as one credit (e.g., one penny, nickel, dime, quarter or dollar) up to a maximum number of credits, such as five credits. This wager may be made by the player a single time or multiple times in a single play of the primary game. For instance, a slot game may have one or more paylines and the slot game may enable the player to make a wager on each payline in a single play of the primary game. Thus, it is known that a gaming machine, such as a slot game, may enable players to make wagers of substantially different amounts on each play of the primary or base game ranging, for example, from 1 credit up to 125 credits (e.g., 5 credits on each of 25 separate paylines). This is also true for other wagering games, such as video draw poker, where players can wager one or more credits on each hand and where multiple hands can be played simultaneously. Accordingly, it should be appreciated that different players play at substantially different wagering amounts or levels and at substantially different rates of play.

Secondary or bonus games are also known in gaming machines. The secondary or bonus games usually provide an additional award to the player. Secondary or bonus games usually do not require an additional wager by the player to be activated. Secondary or bonus games are generally activated or triggered upon an occurrence of a designated triggering symbol or triggering symbol combination in the primary or base game. For instance, a bonus symbol occurring on the payline on the third reel of a three reel slot machine may trigger the secondary bonus game. Part of the enjoyment and excitement of playing certain gaming machines is the occurrence or triggering of the secondary or bonus game (even before the player knows how much the bonus award will be). In other words, obtaining a bonus event and a bonus award in the bonus event is part of the enjoyment and excitement for players.

Progressive awards associated with gaming machines are also known. In one form, a progressive award is an award amount which includes an initial amount funded by a casino and an additional amount funded through a portion of each wager made on the progressive gaming machine. For example, 0.1% of each wager placed on the primary game of the gaming machine associated with the progressive award may be allocated to the progressive award or progressive award fund or pool. The progressive award grows in value as more players play the gaming machines and more portions of these players' wagers are allocated to the progressive award. When a player obtains a winning symbol or symbol combination associated with the progressive award, the accumulated progressive award is provided to the player. After the progressive award is provided to the player, the amount of the next progressive award is reset to the initial value and a portion of each subsequent wager on a gaming machine associated with a progressive award is allocated to the next progressive award.

A progressive award may be associated with or otherwise dedicated to a single or stand-alone gaming machine. Alternatively, a progressive award may be associated with or otherwise dedicated to multiple gaming machines which each contribute a portion of wagers placed at such gaming machine(s) to the progressive award. The multiple gaming machines may be in the same bank of gaming machines, in the same casino or gaming establishment (usually through a local area network (“LAN”)) or in two or more different casinos or gaming establishments (usually through a wide area network (“WAN”)). Such progressive awards are played for by one or more gaming devices in the same gaming establishment sometimes called local area progressives (“LAP”) and such progressive awards played for by a plurality of gaming devices at a plurality of different gaming establishments are sometimes called wide area progressives (“WAP”).

Moreover, a gaming machine or bank of gaming machines may be simultaneously associated with a plurality of progressive awards. In these multi-level progressive (“MLP”) configurations, a plurality of progressive awards start at different award or value levels, such as $10, $100, $1000 and $10,000 and each individually increment or increase until provided to a player. Upon a suitable triggering event at one of more of the gaming devices associated with the MLP, one or more of the progressive awards which form the MLP are provided to one or more of the players at such gaming devices.

Mystery bonus awards are also known. For instance, U.S. Pat. Nos. 5,655,961, 5,702,304, 5,741,183, 5,752,882, 5,820,459, 5,836,817, 5,876,284, 6,162,122, 6,257,981, 6,319,125, 6,364,768, 6,375,569, 6,375,567, RE37,885 and 6,565,434 describe mystery bonus awards and certain methods for providing such awards to players. These patents also describe certain methods for determining which gaming machines will provide the awards to players. These patents further describe methods for a central server to determine which gaming machines will provide the bonus awards and the amount of the bonus awards.

PCT Application No. PCT/AU98/00525, entitled “Slot Machine Game And System With Improved Jackpot Feature” discloses a jackpot awardable to a plurality of gaming machines connected to a network. Upon each play of each gaming machine, a jackpot controller increments the value of the jackpot. Prior to each primary game, the gaming machine selects a random number from a range of numbers and during each primary game, the gaming machine allocates a plurality of numbers in the range, where the plurality of numbers is proportional to the wager. At the end of the primary game, the randomly selected number is compared with the numbers allocated to the player and if a match occurs, that particular gaming machine is switched into a feature game mode in which a jackpot game is played for all or part of the incremental jackpot.

PCT Application No. PCT/AU99/01059, entitled “Player Information Delivery” discloses a gaming console in which an animated character occasionally randomly appears and awards a player a variable random bonus prize. The occurrence of the animated character is weighted by the desired hit rate of the feature and is dependent upon the player's bet and may or may not be dependent upon the size and type of the player's bet. Additionally, the gaming console includes a bonus pool (funded by the player) and a random decision is made whether the contents of the bonus pool will be awarded in addition to any other win.

U.S. Pat. No. 6,241,608 B1 entitled “Progressive Wagering System” discloses a linked progressive wagering system specifying a boundary criteria, such as a maximum value or an expiration date and time, for a progressive award prize. If a gaming device has not randomly generated a prize award event when the specified boundary criteria is met, a progressive award prize is forced by the system upon one or more randomly selected participating players.

There is a continuing need to provide new and different gaming machines and gaming systems as well as new and different ways to provide awards to players including bonus awards.

There is also a continuing need to provide new and different gaming machines and gaming systems which are operable to control the volatility for the frequency at which providing one or more bonus awards occur.

### SUMMARY

In one embodiment, the gaming system disclosed herein includes at least one and preferably a plurality of progressive awards or progressive incremented values adapted to be provided to a player. In one embodiment, upon a suitable initiating event, a wager amount or value is randomly generated from a predetermined range of wager amounts or values. In one such embodiment, to increase the volatility of how often the triggering event occurs, the predetermined range of wager amounts or values is selected from a plurality of different predetermined ranges of wager amounts or values. In these embodiments, how often the triggering event occurs is based on the size of the selected predetermined range. In one embodiment, upon an occurrence of a suitable triggering event, such as an accumulated wager pool incrementing to the randomly generated wager amount or value, a designated award, such as a progressive award, is provided to a player. In another embodiment, upon the occurrence of the triggering event, an independent determination occurs regarding which one of a plurality of progressive awards will be provided to a player.

In one embodiment, the gaming system disclosed herein includes a central server, central controller or remote host in communication with or linked to a plurality of gaming machines or gaming devices. In another embodiment, the gaming system includes a plurality of linked gaming machines, wherein one of the gaming machines functions as the central server, central controller or remote host.

In one embodiment, the central controller monitors wagers or wager activity on the primary games of the gaming machines. In one such embodiment, the controller includes a total coin-in or wager meter, such as an accumulated wager pool, which tracks the total coin-in wagers placed on all of the primary games for all of the gaming machines in the gaming system. The controller tracks or allocates the total wagers for all of the gaming machines in the gaming system in any suitable compatible or comparable manner such as credits wagered (i.e., if all of the system gaming machines are of the same denomination) or monetary units (e.g., total dollars or other currency) wagered.

In one embodiment, the controller maintains an accumulated wager pool for all of the gaming machines in the gaming system. The accumulated wager pool includes at least the total coin-in or amounts wagered on the plays of the primary games of the gaming machines in the gaming system during a bonus event accumulation period, such as a progressive award event accumulation period. In one embodiment, each bonus event accumulation period starts at the occurrence of a first bonus event and ends at the occurrence of a second subsequent bonus event. For example, when a bonus event occurs, the accumulation of the monetary units for that bonus event simultaneously or substantially simultaneously ceases. In this example, any wagers made on the primary games of the gaming machines which subsequently occur are part of the next bonus event accumulation period and are accumulated for the next bonus event.

In one embodiment, upon the initiation or beginning of a bonus event accumulation period, the central controller or an individual gaming device processor randomly generates a wager amount or value. In one such embodiment, the central controller or gaming device processor randomly generates the wager amount or value from a predetermined range of wager amounts or values. For example, if a gaming system operator or designer wants a triggering event to occur every 10,000 credits wagered on average, the gaming system designer sets the predetermined range from 1 to 20,000 (with each integer in the range having an equal probability of being randomly generated). It should be appreciated that the size of the predetermined range determines the frequency which a triggering event will occur. That is, the greater the predetermined range, the greater, on average, the randomly generated number from the predetermined range and thus the greater amount of time for the progressive award(s) to increment or grow prior to the accumulated wager pool incrementing to the randomly generated value (and one of the progressive awards being provided to a player).

In another such embodiment, the gaming system includes a plurality of different predetermined ranges of wager amounts or values. In this embodiment, upon the initiation or beginning of a bonus event accumulation period, the central controller or gaming device processor selects one of the plurality of predetermined ranges. From this selected predetermined range of wager amounts or values, the central controller or gaming device processor randomly generates a wager amount or value. For example, if a gaming system designer wants a triggering event to occur every 10,000 credits wagered on average, the gaming system designer sets a first predetermined range from 1 to 10,000; sets a second predetermined range from 1 to 20,000; and sets a third predetermined range from 1 to 30,000. In this example, if each set range has an equal probability of being selected and each integer in each range has an equal probability of being selected, then on average, the triggering event will occur once every 10,000 credits wagered. It should be appreciated that by selecting one range from a plurality of ranges and subsequently selecting one integer from the selected range, the gaming system disclosed herein provides an increased level of volatility for the frequency by which triggering events occur. That is, using variable ranges to determine, at least in part, when a triggering event will occur, provides increased excitement and enjoyment to players who might otherwise become accustomed to triggering events occurs at relatively predictable intervals.

In these embodiments, when the central controller determines that an amount or value tracked in the accumulated wager pool matches (i.e., is equal to or substantially equal to) the amount or value randomly generated from the applicable predetermined range, a triggering event occurs. In one embodiment, upon an occurrence of the triggering event, a designated or bonus award, such as a progressive award, is provided to a player.

In another embodiment, upon an occurrence of the triggering event, the central controller or gaming device processor enables a player to play a secondary or bonus game. In this embodiment, based on one or more independent determinations, one or more progressive awards in a multi-level progressive award configuration are provided to the player.

Accordingly, the gaming system disclosed herein provides new and different gaming machines which are operable to control the volatility for the frequency at which providing one or more bonus awards occur.

Additional features and advantages are described in, and will be apparent from, the following Detailed Description and the figures.

### BRIEF DESCRIPTION OF THE FIGURES

FIGS. 1A and 1B are front perspective views of alternative embodiments of gaming devices disclosed herein.

FIG. 2A is a schematic block diagram of the electronic configuration of one embodiment of a gaming device disclosed herein.

FIG. 2B is a schematic diagram of the central server in communication with a plurality of gaming machines in accordance with one embodiment of the gaming system disclosed herein.

FIG. 3 is a flowchart of one embodiment of the gaming system disclosed herein illustrating a player winning a progressive award.

FIG. 4 is a schematic diagram of the plurality of gaming devices in the gaming system and the plurality of progressive awards maintained by the gaming system.

### DETAILED DESCRIPTION

The present disclosure may be implemented in various configurations for gaming machines or gaming devices, including but not limited to: (1) a dedicated gaming machine or gaming device, wherein the computerized instructions for controlling any games (which are provided by the gaming machine or gaming device) are provided with the gaming machine or gaming device prior to delivery to a gaming establishment; and (2) a changeable gaming machine or gaming device, where the computerized instructions for controlling any games (which are provided by the gaming machine or gaming device) are downloadable to the gaming machine or gaming device through a data network when the gaming machine or gaming device is in a gaming establishment. In one embodiment, the computerized instructions for controlling any games are executed by a central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In one embodiment, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

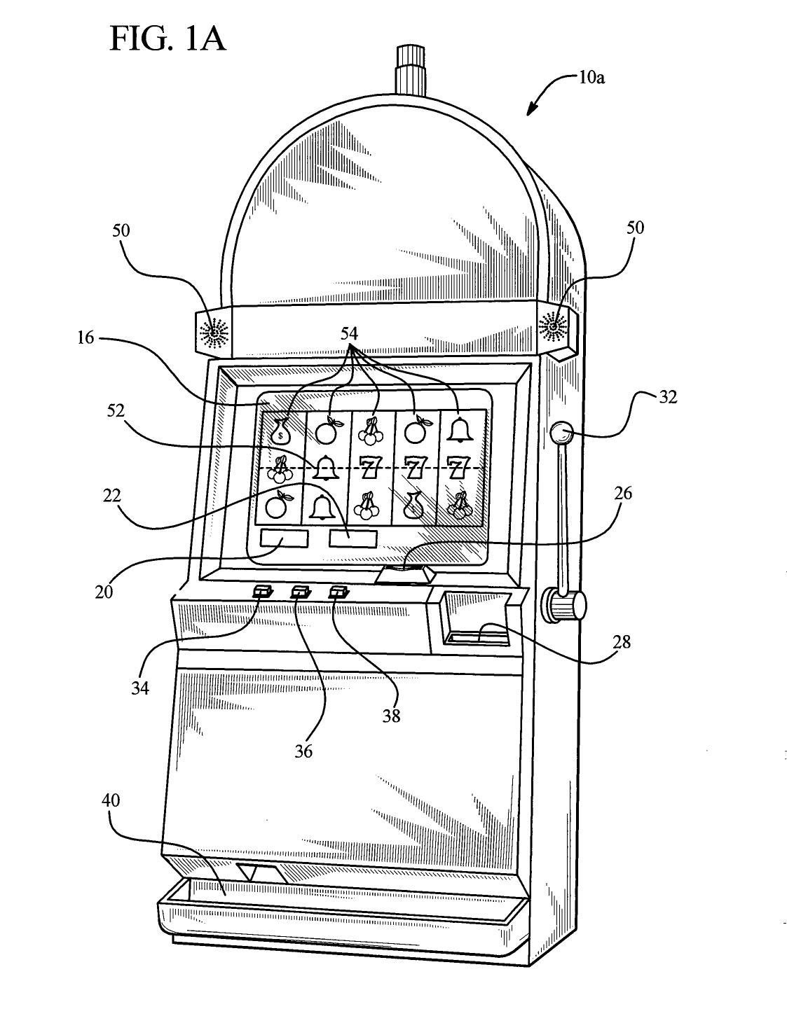

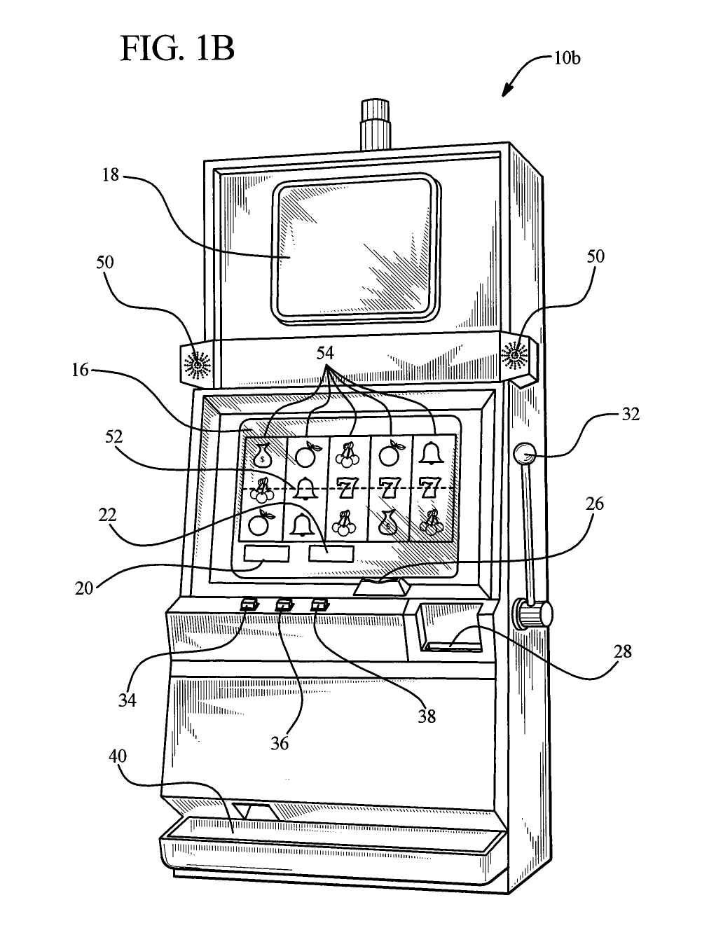

Referring now to the drawings, two example alternative embodiments of the gaming device of the disclosed herein are illustrated in FIGS. 1A and 1B as gaming device 10a and gaming device 10b, respectively. Gaming device 10a and/or gaming device 10b are generally referred to herein as gaming device 10.

In the embodiments illustrated in FIGS. 1A and 1B, gaming device 10 has a support structure, housing or cabinet which provides support for a plurality of displays, inputs, controls and other features of a conventional gaming machine. It is configured so that a player can operate it while standing or sitting. The gaming device may be positioned on a base or stand or can be configured as a pub-style table-top game (not shown) which a player can operate preferably while sitting. As illustrated by the different configurations shown in FIGS. 1A and 1B, the gaming device may have varying cabinet and display configurations.

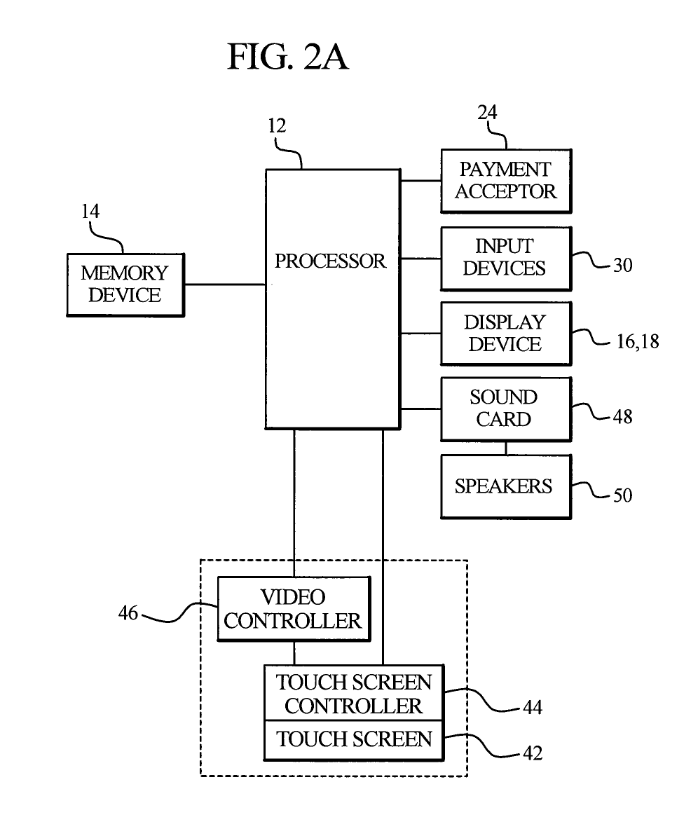

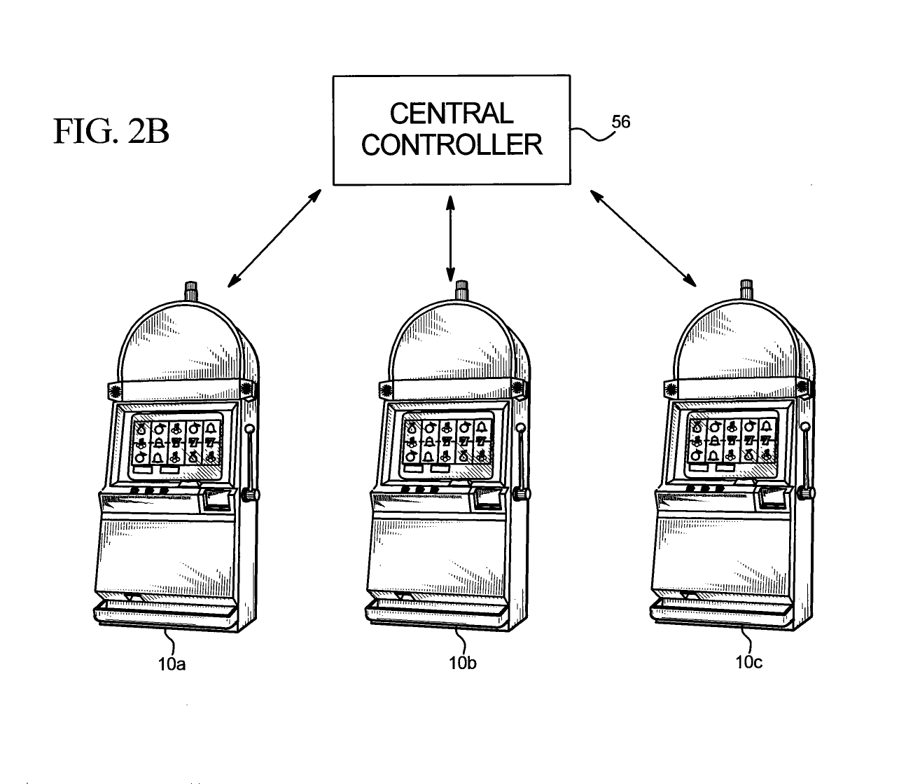

In one embodiment, as illustrated in FIG. 2A, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information and applicable game rules that relate to the play of the gaming device. In one embodiment, the memory device includes random access memory (RAM), which can include non-volatile RAM (NVRAM), magnetic RAM (MRAM), ferroelectric RAM (FeRAM) and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD or USB memory device. In other embodiments, part or all of the program code and/or operating data described above can be downloaded to the memory device through a suitable network.

In one embodiment, an operator or a player can use such a removable memory device in a desktop computer, a laptop personal computer, a personal digital assistant (PDA), portable computing device, or other computerized platform to implement the present disclosure. In one embodiment, the gaming device or gaming machine disclosed herein is operable over a wireless network, such as part of a wireless gaming system. In this embodiment, the gaming machine may be a hand held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “computer” or “controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device flags or removes the provided award or other game outcome from the predetermined set or pool. Once flagged or removed from the set or pool, the specific provided award or other game outcome from that specific pool cannot be provided to the player again. This type of gaming device provides players with all of the available awards or other game outcomes over the course of the play cycle and guarantees the amount of actual wins and losses.

In another embodiment, as discussed below, upon a player initiating game play at the gaming device, the gaming device enrolls in a bingo game. In this embodiment, a bingo server calls the bingo balls that result in a specific bingo game outcome. The resultant game outcome is communicated to the individual gaming device to be provided to a player. In one embodiment, this bingo outcome is displayed to the player as a bingo game and/or in any form in accordance with the present disclosure.

In one embodiment, as illustrated in FIG. 2A, the gaming device includes one or more display devices controlled by the processor. The display devices are preferably connected to or mounted to the cabinet of the gaming device. The embodiment shown in FIG. 1A includes a central display device 16 which displays a primary game. This display device may also display any suitable secondary game associated with the primary game as well as information relating to the primary or secondary game. The alternative embodiment shown in FIG. 1B includes a central display device 16 and an upper display device 18. The upper display device may display the primary game, any suitable secondary game associated or not associated with the primary game and/or information relating to the primary or secondary game. As seen in FIGS. 1A and 1B, in one embodiment, the gaming device includes a credit display 20 which displays a player's current number of credits, cash, account balance or the equivalent. In one embodiment, gaming device includes a bet display 22 which displays a player's amount wagered.

In another embodiment, at least one display device may be a mobile display device, such as a PDA or tablet PC, that enables play of at least a portion of the primary or secondary game at a location remote from the gaming device.

The display devices may include, without limitation, a monitor, a television display, a plasma display, a liquid crystal display (LCD) a display based on light emitting diodes (LED), a display based on a plurality of organic light-emitting diodes (OLEDs), a display based on polymer light-emitting diodes (PLEDs), a display based on a plurality of surface-conduction electron-emitters (SEDs), a display including a projected and/or reflected image or any other suitable electronic device or display mechanism. In one embodiment, as described in more detail below, the display device includes a touch-screen with an associated touch-screen controller. The display devices may be of any suitable size and configuration, such as a square, a rectangle or an elongated rectangle.

The display devices of the gaming device are configured to display at least one and preferably a plurality of game or other suitable images, symbols and indicia such as any visual representation or exhibition of the movement of objects such as mechanical, virtual or video reels and wheels, dynamic lighting, video images, images of people, characters, places, things and faces of cards, and the like.

In one alternative embodiment, the symbols, images and indicia displayed on or of the display device may be in mechanical form. That is, the display device may include any electromechanical device, such as one or more mechanical objects, such as one or more rotatable wheels, reels or dice, configured to display at least one or a plurality of game or other suitable images, symbols or indicia.

As illustrated in FIG. 2A, in one embodiment, the gaming device includes at least one payment acceptor 24 in communication with the processor. As seen in FIGS. 1A and 1B, the payment acceptor may include a coin slot 26 and a payment, note or bill acceptor 28, where the player inserts money, coins or tokens. The player can place coins in the coin slot or paper money, a ticket or voucher into the payment, note or bill acceptor. In other embodiments, devices such as readers or validators for credit cards, debit cards or credit slips may accept payment. In one embodiment, a player may insert an identification card into a card reader of the gaming device. In one embodiment, the identification card is a smart card having a programmed microchip or a magnetic strip coded with a player's identification, credit totals (or related data) and other relevant information. In another embodiment, a player may carry a portable device, such as a cell phone, a radio frequency identification tag or any other suitable wireless device, which communicates a player's identification, credit totals (or related data) and other relevant information to the gaming device. In one embodiment, money may be transferred to a gaming device through electronic funds transfer. When a player funds the gaming device, the processor determines the amount of funds entered and displays the corresponding amount on the credit or other suitable display as described above.

As seen in FIGS. 1A, 1B and 2A, in one embodiment the gaming device includes at least one and preferably a plurality of input devices 30 in communication with the processor. The input devices can include any suitable device which enables the player to produce an input signal which is received by the processor. In one embodiment, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In one embodiment, upon appropriate funding, the gaming device begins the game play automatically. In another embodiment, upon the player engaging one of the play buttons, the gaming device automatically activates game play.

In one embodiment, as shown in FIGS. 1A and 1B, one input device is a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms such as tickets or credit slips redeemable by a cashier (or other suitable redemption system) or funding to the player's electronically recordable identification card.

In one embodiment, as mentioned above and seen in FIG. 2A, one input device is a touch-screen 42 coupled with a touch-screen controller 44, or some other touch-sensitive display overlay to allow for player interaction with the images on the display. The touch-screen and the touch-screen controller are connected to a video controller 46. A player can make decisions and input signals into the gaming device by touching the touch-screen at the appropriate places. One such input device is a touch-screen button panel. It should be appreciated that the utilization of touch-screens is widespread in the gaming industry.

The gaming device may further include a plurality of communication ports for enabling communication of the processor with external peripherals, such as external video sources, expansion buses, game or other displays, an SCSI port or a key pad.

In one embodiment, as seen in FIG. 2A, the gaming device includes a sound generating device controlled by one or more sounds cards 48 which function in conjunction with the processor. In one embodiment, the sound generating device includes at least one and preferably a plurality of speakers 50 or other sound generating hardware and/or software for generating sounds, such as playing music for the primary and/or secondary game or for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In one embodiment, the gaming machine may include a sensor, such as a camera in communication with the processor (and possibly controlled by the processor) that is selectively positioned to acquire an image of a player actively using the gaming device and/or the surrounding area of the gaming device. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and the processor may incorporate that image into the primary and/or secondary game as a game image, symbol or indicia.

In one embodiment, as illustrated in FIG. 2B, one or more of the gaming devices 10 are in communication with each other and/or at least one central server, central controller or remote host 56 through a data network or remote communication link. These gaming devices and the central server form the gaming system disclosed herein. In this embodiment, the central server, central controller or remote host is any suitable server or computing device which includes at least one processor and at least one memory or storage device. The number of gaming machines in the gaming system can vary as desired by the implementer of the gaming system. These gaming machines are referred to herein alternatively as the group of gaming machines, the linked gaming machines or the system gaming machines. The linked gaming machines may be of the same type or of different types of gaming machines. The linked gaming machines may have the same primary game or two or more different primary games. For example, one gaming machine may be adapted to play a slot game while another gaming machine may be adapted to play a poker game. The linked gaming machines may have no secondary games, one or more secondary games, the same secondary games or two or more different secondary games. The terms central server, central controller and remote host are used interchangeably herein.

In different such embodiments, the central server is a progressive controller or a processor of one of the gaming devices in the gaming system. In these embodiments, the processor of each gaming device is designed to transmit and receive events, messages, commands or any other suitable data or signal between the individual gaming device and the central server. The gaming device processor is operable to execute such communicated events, messages or commands in conjunction with the operation of the gaming device. Moreover, the processor of the central server is designed to transmit and receive events, messages, commands or any other suitable data or signal between the central server and each of the individual gaming devices. The central server processor is operable to execute such communicated events, messages or commands in conjunction with the operation of the central server. It should be appreciated that one, more or each of the functions of the central controller as disclosed herein may be performed by one or more gaming device processors. It should be further appreciated that one, more or each of the functions of one or more gaming device processors as disclosed herein may be performed by the central controller.

In one embodiment, a plurality of the gaming devices are capable of being connected together through a data network. In one embodiment, the data network is a local area network (LAN), in which one or more of the gaming devices are substantially proximate to each other and an on-site central server as in, for example, a gaming establishment or a portion of a gaming establishment. In another embodiment, the data network is a wide area network (WAN) in which one or more of the gaming devices are in communication with at least one off-site central server. In this embodiment, the plurality of gaming devices may be located in a different part of the gaming establishment or within a different gaming establishment than the off-site central server. Thus, the WAN may include an off-site central server and an off-site gaming device located within gaming establishments in the same geographic area, such as a city or state. The WAN gaming system may be substantially identical to the LAN gaming system described above, although the number of gaming devices in each system may vary relative to each other.

In another embodiment, the data network is an internet or intranet. In this embodiment, the operation of the gaming device can be viewed at the gaming device with at least one internet browser. In this embodiment, operation of the gaming device and accumulation of credits may be accomplished with only a connection to the central server (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer, or other internet facilitator is available. The expansion in the number of computers and number and speed of internet connections in recent years increases opportunities for players to play from an ever-increasing number of remote sites. It should be appreciated that enhanced bandwidth of digital wireless communications may render such technology suitable for some or all communications, particularly if such communications are encrypted. Higher data transmission speeds may be useful for enhancing the sophistication and response of the display and interaction with the player.

Gaming device 10 can incorporate any suitable wagering primary or base game. The gaming machine or device may include some or all of the features of conventional gaming machines or devices. The primary or base game may comprise any suitable reel-type game, card game, cascading or falling symbol game, number game or other game of chance susceptible to representation in an electronic or electromechanical form, which in one embodiment produces a random outcome based on probability data at the time of or after placement of a wager. That is, different primary wagering games, such as video poker games, video blackjack games, video keno, video bingo or any other suitable primary or base game may be implemented.

In one embodiment, as illustrated in FIGS. 1A and 1B, a base or primary game may be a slot game with one or more paylines 52. The paylines may be horizontal, vertical, circular, diagonal, angled or any combination thereof. In this embodiment, the gaming device includes at least one and preferably a plurality of reels 54, such as three to five reels 54, in either electromechanical form with mechanical rotating reels or video form with simulated reels and movement thereof. In one embodiment, an electromechanical slot machine includes a plurality of adjacent, rotatable reels which may be combined and operably coupled with an electronic display of any suitable type. In another embodiment, if the reels 54 are in video form, one or more of the display devices, as described above, display the plurality of simulated video reels 54. Each reel 54 displays a plurality of indicia such as bells, hearts, fruits, numbers, letters, bars or other images which preferably correspond to a theme associated with the gaming device. In this embodiment, the gaming device awards prizes after the reels of the primary game stop spinning if specified types and/or configurations of indicia or symbols occur on an active payline or otherwise occur in a winning pattern, occur on the requisite number of adjacent reels and/or occur in a scatter pay arrangement.

In an alternative embodiment, rather than determining any outcome to provide to the player by analyzing the symbols generated on any wagered upon paylines as described above, the gaming device determines any outcome to provide to the player based on the number of associated symbols which are generated in active symbol positions on the requisite number of adjacent reels (i.e., not on paylines passing through any displayed winning symbol combinations). In this embodiment, if a winning symbol combination is generated on the reels, the gaming device provides the player one award for that occurrence of the generated winning symbol combination. For example, if one winning symbol combination is generated on the reels, the gaming device will provide a single award to the player for that winning symbol combination (i.e., not based on paylines that would have passed through that winning symbol combination). It should be appreciated that because a gaming device with wagering on ways to win provides the player one award for a single occurrence of a winning symbol combination and a gaming device with paylines may provide the player more than one award for the same occurrence of a single winning symbol combination (i.e., if a plurality of paylines each pass through the same winning symbol combination), it is possible to provide a player at a ways to win gaming device more ways to win for an equivalent bet or wager on a traditional slot gaming device with paylines.

In one embodiment, the total number of ways to win is determined by multiplying the number of symbols generated in active symbol positions on a first reel by the number of symbols generated in active symbol positions on a second reel by the number of symbols generated in active symbol positions on a third reel and so on for each reel of the gaming device with at least one symbol generated in an active symbol position. For example, a three reel gaming device with three symbols generated in active symbol positions on each reel includes 27 ways to win (i.e., 3 symbols on the first reel×3 symbols on the second reel×3 symbols on the third reel). A four reel gaming device with three symbols generated in active symbol positions on each reel includes 81 ways to win (i.e., 3 symbols on the first reel×3 symbols on the second reel×3 symbols on the third reel×3 symbols on the fourth reel). A five reel gaming device with three symbols generated in active symbol positions on each reel includes 243 ways to win (i.e., 3 symbols on the first reel×3 symbols on the second reel×3 symbols on the third reel×3 symbols on the fourth reel×3 symbols on the fifth reel). It should be appreciated that modifying the number of generated symbols by either modifying the number of reels or modifying the number of symbols generated in active symbol positions by one or more of the reels, modifies the number of ways to win.

In another embodiment, the gaming device enables a player to wager on and thus activate symbol positions. In one such embodiment, the symbol positions are on the reels. In this embodiment, if based on the player's wager, a reel is activated, then each of the symbol positions of that reel will be activated and each of the active symbol positions will be part of one or more of the ways to win. In one embodiment, if based on the player's wager, a reel is not activated, then a designated number of default symbol positions, such as a single symbol position of the middle row of the reel, will be activated and the default symbol position(s) will be part of one or more of the ways to win. This type of gaming machine enables a player to wager on one, more or each of the reels and the processor of the gaming device uses the number of wagered on reels to determine the active symbol positions and the number of possible ways to win. In alternative embodiments, (1) no symbols are displayed as generated at any of the inactive symbol positions, or (2) any symbols generated at any inactive symbol positions may be displayed to the player but suitably shaded or otherwise designated as inactive.

In one embodiment wherein a player wagers on one or more reels, a player's wager of one credit may activate each of the three symbol positions on a first reel, wherein one default symbol position is activated on each of the remaining four reels. In this example, as described above, the gaming device provides the player three ways to win (i.e., 3 symbols on the first reel×1 symbol on the second reel×1 symbol on the third reel×1 symbol on the fourth reel×1 symbol on the fifth reel). In another example, a player's wager of nine credits may activate each of the three symbol positions on a first reel, each of the three symbol positions on a second reel and each of the three symbol positions on a third reel wherein one default symbol position is activated on each of the remaining two reels. In this example, as described above, the gaming device provides the player twenty-seven ways to win (i.e., 3 symbols on the first reel×3 symbols on the second reel×3 symbols on the third reel×1 symbol on the fourth reel×1 symbol on the fifth reel).

In one embodiment, to determine any award(s) to provide to the player based on the generated symbols, the gaming device individually determines if a symbol generated in an active symbol position on a first reel forms part of a winning symbol combination with or is otherwise suitably related to a symbol generated in an active symbol position on a second reel. In this embodiment, the gaming device classifies each pair of symbols which form part of a winning symbol combination (i.e., each pair of related symbols) as a string of related symbols. For example, if active symbol positions include a first cherry symbol generated in the top row of a first reel and a second cherry symbol generated in the bottom row of a second reel, the gaming device classifies the two cherry symbols as a string of related symbols because the two cherry symbols form part of a winning symbol combination.

After determining if any strings of related symbols are formed between the symbols on the first reel and the symbols on the second reel, the gaming device determines if any of the symbols from the next adjacent reel should be added to any of the formed strings of related symbols. In this embodiment, for a first of the classified strings of related symbols, the gaming device determines if any of the symbols generated by the next adjacent reel form part of a winning symbol combination or are otherwise related to the symbols of the first string of related symbols. If the gaming device determines that a symbol generated on the next adjacent reel is related to the symbols of the first string of related symbols, that symbol is subsequently added to the first string of related symbols. For example, if the first string of related symbols is the string of related cherry symbols and a related cherry symbol is generated in the middle row of the third reel, the gaming device adds the related cherry symbol generated on the third reel to the previously classified string of cherry symbols.

On the other hand, if the gaming device determines that no symbols generated on the next adjacent reel are related to the symbols of the first string of related symbols, the gaming device marks or flags such string of related symbols as complete. For example, if the first string of related symbols is the string of related cherry symbols and none of the symbols of the third reel are related to the cherry symbols of the previously classified string of cherry symbols, the gaming device marks or flags the string of cherry symbols as complete.

After either adding a related symbol to the first string of related symbols or marking the first string of related symbols as complete, the gaming device proceeds as described above for each of the remaining classified strings of related symbols which were previously classified or formed from related symbols on the first and second reels.

After analyzing each of the remaining strings of related symbols, the gaming device determines, for each remaining pending or incomplete string of related symbols, if any of the symbols from the next adjacent reel, if any, should be added to any of the previously classified strings of related symbols. This process continues until either each string of related symbols is complete or there are no more adjacent reels of symbols to analyze. In this embodiment, where there are no more adjacent reels of symbols to analyze, the gaming device marks each of the remaining pending strings of related symbols as complete.

When each of the strings of related symbols is marked complete, the gaming device compares each of the strings of related symbols to an appropriate paytable and provides the player any award associated with each of the completed strings of symbols. It should be appreciated that the player is provided one award, if any, for each string of related symbols generated in active symbol positions (i.e., as opposed to being based on how many paylines that would have passed through each of the strings of related symbols in active symbol positions).

In one embodiment, a base or primary game may be a poker game wherein the gaming device enables the player to play a conventional game of video draw poker and initially deals five cards all face up from a virtual deck of fifty-two card deck. Cards may be dealt as in a traditional game of cards or in the case of the gaming device, may also include that the cards are randomly selected from a predetermined number of cards. If the player wishes to draw, the player selects the cards to hold via one or more input device, such as pressing related hold buttons or via the touch screen. The player then presses the deal button and the unwanted or discarded cards are removed from the display and the gaming machine deals the replacement cards from the remaining cards in the deck. This results in a final five-card hand. The gaming device compares the final five-card hand to a payout table which utilizes conventional poker hand rankings to determine the winning hands. The gaming device provides the player with an award based on a winning hand and the credits the player wagered.

In another embodiment, the base or primary game may be a multi-hand version of video poker. In this embodiment, the gaming device deals the player at least two hands of cards. In one such embodiment, the cards are the same cards. In one embodiment each hand of cards is associated with its own deck of cards. The player chooses the cards to hold in a primary hand. The held cards in the primary hand are also held in the other hands of cards. The remaining non-held cards are removed from each hand displayed and for each hand replacement cards are randomly dealt into that hand. Since the replacement cards are randomly dealt independently for each hand, the replacement cards for each hand will usually be different. The poker hand rankings are then determined hand by hand and awards are provided to the player.

In one embodiment, a base or primary game may be a keno game wherein the gaming device displays a plurality of selectable indicia or numbers on at least one of the display devices. In this embodiment, the player selects at least one or a plurality of the selectable indicia or numbers via an input device such as the touch screen. The gaming device then displays a series of drawn numbers to determine an amount of matches, if any, between the player's selected numbers and the gaming device's drawn numbers. The player is provided an award based on the amount of matches, if any, based on the amount of determined matches.

In one embodiment, in addition to winning credits or other awards in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game. In one embodiment, the bonus or secondary game may be any type of suitable game, either similar to or completely different from the base or primary game.

In one embodiment, the triggering event or qualifying condition may be a selected outcome in the primary game or a particular arrangement of one or more indicia on a display device in the primary game, such as the number seven appearing on three adjacent reels along a payline in the primary slot game embodiment seen in FIGS. 1A and 1B. In other embodiments, the triggering event or qualifying condition may be by exceeding a certain amount of game play (such as number of games, number of credits, amount of time), or reaching a specified number of points earned during game play.

In another embodiment, the gaming device processor 12 or central server 56 randomly provides the player one or more plays of one or more secondary games. In one such embodiment, the gaming device does not provide any apparent reasons to the player for qualifying to play a secondary or bonus game. In this embodiment, qualifying for a bonus game is not triggered by an event in or based specifically on any of the plays of any primary game. In another embodiment, the gaming device (or central server) qualifies a player for a secondary game at least partially based on a game triggered or symbol triggered event, such as at least partially based on the play of a primary game.

In one embodiment, the gaming device includes a program which will automatically begin a bonus round after the player has achieved a triggering event or qualifying condition in the base or primary game. In another embodiment, after a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or exponential increase in the number of bonus wagering credits awarded. In one embodiment, the player may redeem extra bonus wagering credits during the bonus game to extend play of the bonus game.

In one embodiment, no separate entry fee or buy in for a bonus game need be employed. That is, a player may not purchase an entry into a bonus game, rather they must win or earn entry through play of the primary game thus, encouraging play of the primary game. In another embodiment, qualification of the bonus or secondary game is accomplished through a simple “buy in” by the player, for example, if the player has been unsuccessful at qualifying through other specified activities. In another embodiment, the player must make a separate side-wager on the bonus game or wager a designated amount in the primary game to qualify for the secondary game. In this embodiment, the secondary game triggering event must occur and the side-wager (or designated primary game wager amount) must have been placed to trigger the secondary game.

In one embodiment, the game outcome provided to the player is determined by a central server and provided to the player at the gaming device. In this embodiment, each of a plurality of such gaming devices are in communication with the central server. Upon a player initiating game play at one of the gaming devices, the initiated gaming device communicates a game outcome request to the central server.

In one embodiment, the central server receives the game outcome request and randomly generates a game outcome for the primary game based on probability data. In another embodiment, the central server randomly generates a game outcome for the secondary game based on probability data. In another embodiment, the central server randomly generates a game outcome for both the primary game and the secondary game based on probability data. In this embodiment, the central server is capable of storing and utilizing program code or other data similar to the processor and memory device of the gaming device.

In an alternative embodiment, the central server maintains one or more predetermined pools or sets of predetermined game outcomes. In this embodiment, the central server receives the game outcome request and independently selects a predetermined game outcome from a set or pool of game outcomes. The central server flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, a predetermined game outcome value is determined for each of a plurality of linked or networked gaming devices based on the results of a bingo, keno or lottery game. In this embodiment, each individual gaming device utilizes one or more bingo, keno or lottery games to determine the predetermined game outcome value provided to the player for the interactive game played at that gaming device. In one embodiment, the bingo, keno or lottery game is displayed to the player. In another embodiment, the bingo, keno or lottery game is not displayed to the player, but the results of the bingo, keno or lottery game determine the predetermined game outcome value for the primary or secondary game.

In the various bingo embodiments, as each gaming device is enrolled in the bingo game, such as upon an appropriate wager or engaging an input device, the enrolled gaming device is provided or associated with a different bingo card. Each bingo card consists of a matrix or array of elements, wherein each element is designated with a separate indicia, such as a number. It should be appreciated that each different bingo card includes a different combination of elements. For example, if four bingo cards are provided to four enrolled gaming devices, the same element may be present on all four of the bingo cards while another element may solely be present on one of the bingo cards.

In operation of these embodiments, upon providing or associating a different bingo card to each of a plurality of enrolled gaming devices, the central controller randomly selects or draws, one at a time, a plurality of the elements. As each element is selected, a determination is made for each gaming device as to whether the selected element is present on the bingo card provided to that enrolled gaming device. This determination can be made by the central controller, the gaming device, a combination of the two, or in any other suitable manner. If the selected element is present on the bingo card provided to that enrolled gaming device, that selected element on the provided bingo card is marked or flagged. This process of selecting elements and marking any selected elements on the provided bingo cards continues until one or more predetermined patterns are marked on one or more of the provided bingo cards. It should be appreciated that in one embodiment, the gaming device requires the player to engage a daub button (not shown) to initiate the process of the gaming device marking or flagging any selected elements.

After one or more predetermined patterns are marked on one or more of the provided bingo cards, a game outcome is determined for each of the enrolled gaming devices based, at least in part, on the selected elements on the provided bingo cards. As described above, the game outcome determined for each gaming device enrolled in the bingo game is utilized by that gaming device to determine the predetermined game outcome provided to the player. For example, a first gaming device to have selected elements marked in a predetermined pattern is provided a first outcome of win $10 which will be provided to a first player regardless of how the first player plays in a first game and a second gaming device to have selected elements marked in a different predetermined pattern is provided a second outcome of win $2 which will be provided to a second player regardless of how the second player plays a second game. It should be appreciated that as the process of marking selected elements continues until one or more predetermined patterns are marked, this embodiment insures that at least one bingo card will win the bingo game and thus at least one enrolled gaming device will provide a predetermined winning game outcome to a player. It should be appreciated that other suitable methods for selecting or determining one or more predetermined game outcomes may be employed.

In one example of the above-described embodiment, the predetermined game outcome may be based on a supplemental or intermittent award in addition to any award provided for winning the bingo game as described above. In this embodiment, if one or more elements are marked in supplemental patterns within a designated number of drawn elements, a supplemental or intermittent award or value associated with the marked supplemental pattern is provided to the player as part of the predetermined game outcome. For example, if the four corners of a bingo card are marked within the first twenty selected elements, a supplemental award of $10 is provided to the player as part of the predetermined game outcome. It should be appreciated that in this embodiment, the player of a gaming device may be provided a supplemental or intermittent award regardless of if the enrolled gaming device's provided bingo card wins or does not win the bingo game as described above.

In another embodiment, one or more of the gaming devices are in communication with a central server for monitoring purposes only. That is, each individual gaming device randomly generates the game outcomes to be provided to the player and the central server monitors the activities and events occurring on the plurality of gaming devices. In one embodiment, the gaming network includes a real-time or on-line accounting and gaming information system operably coupled to the central server. The accounting and gaming information system of this embodiment includes a player database for storing player profiles, a player tracking module for tracking players and a credit system for providing automated casino transactions.

In one embodiment, the gaming device disclosed herein is associated with or otherwise integrated with one or more player tracking systems. In this embodiment, the gaming device and/or player tracking system tracks any players gaming activity at the gaming device. In one such embodiment, the gaming device and/or associated player tracking system timely tracks when a player inserts their playing tracking card to begin a gaming session and also timely tracks when a player removes their player tracking card when concluding play for that gaming session. In another embodiment, rather than requiring a player to insert a player tracking card, the gaming device utilizes one or more portable devices carried by a player, such as a cell phone, a radio frequency identification tag or any other suitable wireless device to track when a player begins and ends a gaming session. In another embodiment, the gaming device utilizes any suitable biometric technology or ticket technology to track when a player begins and ends a gaming session.

During one or more gaming sessions, the gaming device and/or player tracking system tracks any suitable information, such as any amounts wagered, average wager amounts and/or the time these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data.

In another embodiment, a plurality of players at a plurality of linked gaming devices in a gaming system participate in a group gaming environment. In one embodiment, a plurality of players at a plurality of linked gaming devices work in conjunction with one another, such as playing together as a team or group, to win one or more awards. In one such embodiment, any award won by the group is shared, either equally or based on any suitable criteria, amongst the different players of the group. In another embodiment, a plurality of players at a plurality of linked gaming devices compete against one another for one or more awards. In one such embodiment, a plurality of players at a plurality of linked gaming devices participate in a gaming tournament for one or more awards. In another embodiment, a plurality of players at a plurality of linked gaming devices play for one or more awards wherein an outcome generated by one gaming device affects the outcomes generated by one or more linked gaming devices.

As mentioned above, in one embodiment, the present disclosure may be employed in a server based gaming system. In one such embodiment, as described above, one or more gaming devices are in communication with a central server. The central server may be any suitable server or computing device which includes at least one processor and at least one memory or storage device. In alternative embodiments, the central server is a progressive controller or another gaming machine in the gaming system. In one embodiment, the memory device of the central server stores different game programs and instructions, executable by a gaming device processor, to control the gaming device. Each executable game program represents a different game or type of game which may be played on one or more of the gaming devices in the gaming system. Such different games may include the same or substantially the same game play with different pay tables. In different embodiments, the executable game program is for a primary game, a secondary game or both. In another embodiment, the game program may be executable as a secondary game to be played simultaneous with the play of a primary game (which may be downloaded to or fixed on the gaming device) or vice versa.

In this embodiment, each gaming device at least includes one or more display devices and/or one or more input devices for interaction with a player. A local processor, such as the above-described gaming device processor or a processor of a local server, is operable with the display device(s) and/or the input device(s) of one or more of the gaming devices.

In operation, the central controller is operable to communicate one or more of the stored game programs to at least one local processor. In different embodiments, the stored game programs are communicated or delivered by embedding the communicated game program in a device or a component (e.g., a microchip to be inserted in a gaming device), writing the game program on a disc or other media, downloading or streaming the game program over a dedicated data network, internet or a telephone line. After the stored game programs are communicated from the central server, the local processor executes the communicated program to facilitate play of the communicated program by a player through the display device(s) and/or input device(s) of the gaming device. That is, when a game program is communicated to a local processor, the local processor changes the game or type of game played at the gaming device.

### Progressive Awards

In one embodiment, a plurality of gaming devices at one or more gaming sites are networked to the central server in a progressive configuration, wherein a portion of each wager placed is allocated to one or more progressive awards or progressive incremented values. In one embodiment, the progressive awards are associated with the system gaming machines which each contribute portions of the progressive awards. In one such embodiment, different progressive awards are associated with different numbers of gaming devices. For example, a progressive award valued at $10,000 may be associated with ten gaming devices while another progressive award valued at $500,000 may be associated with one-hundred gaming devices. In one embodiment, the multiple gaming machines may be in the same bank of machines, in the same casino or gaming establishment (such as through LAN), or in two or more different casinos or gaming establishments (such as through a WAN). In another embodiment, each individual gaming machine maintains one or more progressive awards wherein a portion of the wagers placed at that respective gaming machine is allocated to one or more progressive awards maintained by such individual gaming machine. In another embodiment, each individual gaming machine maintains one or more progressive awards and the central server simultaneously or substantially simultaneously maintains one or more progressive awards. In one such embodiment, the lower valued, more frequently triggered progressive awards are maintained by the individual gaming machines and the higher valued, less frequently triggered progressive awards are maintained by the central server. In one embodiment, a portion of each wager placed at a designated gaming device is allocated to one or more progressive awards associated with that designated gaming device. In another embodiment, a portion designated wagers placed at a designated gaming device, such as a portion of each maximum wager placed or a portion of each side wager placed, is allocated to one or more progressive awards associated with that designated gaming device.

In one embodiment, a master host site computer is coupled to a plurality of the central servers at a variety of mutually remote gaming sites for providing a multi-site linked progressive automated gaming system. In one embodiment, a master host site computer may serve gaming devices distributed throughout a number of properties at different geographical locations including, for example, different locations within a city or different cities within a state. In one embodiment, the master host site computer is maintained for the overall operation and control of the system. In this embodiment, a master host site computer oversees all or part of the progressive gaming system and is the master for computing all or part of the progressive jackpots. All participating gaming sites report to, and receive information from, the master host site computer. Each central server computer is responsible for all data communication between the gaming device hardware and software and the master host site computer.

In one embodiment, one or more of the progressive awards start at different levels such as $10, $100, $1000 and $10,000 and increment or increase until provided to a player. The progressive awards accumulate based on a small percentage (such as 0.1%) of coin-in or wagered amounts in a conventional manner. In one embodiment, the percentage that goes to each progressive award is equal (such as 0.1% to each of four progressive awards). In another embodiment, the percentages of wagered amounts that go to a progressive award for different wager amounts are different. For example, a wager of one to twenty-five credits may increment a progressive award 0.1% of the wager, a wager of twenty-six to fifty credits may increment a progressive award 0.08% of the wager and a wager of fifty-one to seventy-five credits may increment a progressive award 0.07% of the wager. In another embodiment, at least a fraction of the progressive award may be funded by the casino by using a starting value higher than zero to make the progressive awards attractive even after they are reset. In other embodiments, two or more of the progressive awards may be funded by different percentages.

In these embodiments, the central server and/or individual gaming device processor continues to increase the progressive award levels until a progressive award is provided to a player (upon the occurrence of a suitable triggering event), at which point the progressive award is reset and another progressive award starts incrementing from the appropriate default progressive award level. In another embodiment, two or more of the progressive awards may be funded at different temporal rates. In this embodiment, the different progressive awards are incremented or funded in different increments of time wherein until the progressive award hits, a set amount is added to the progressive award at each determined time increment. In another embodiment, two or more of the progressive awards may each be incremented or funded based on different incrementing factors or incrementors. In this embodiment, a first of the progressive awards may increment each time a first incrementing factor occurs and a second of the progressive awards may increment each time a second incrementing factor occurs, wherein the first incrementing factor and the second incrementing factor are different. Examples of incrementing factors could be a symbol-driven trigger in the base game, the occurrence of one or more events in a bonus game, the player betting a maximum amount, a percentage of possible gaming machines being actively played or in active status, or any other suitable method for defining an incrementor.

In one embodiment, different gaming devices in the gaming system have different progressive awards available to the player. In one such embodiment, different types of gaming devices are associated with different types of progressive awards based on the current configuration of the gaming system. In one embodiment, zero, one or more progressive awards may be associated with each of the gaming devices in the gaming system while zero, one or more different progressive awards may be associated with a plurality of, but not all of the gaming devices in the gaming system.

In one alternative embodiment, a central controller and an individual gaming machine work in conjunction with each other to determine when one or more of the progressive award wins are triggered, for example through an individual gaming machine meeting a predetermined requirement or criteria established by the central controller. In another embodiment, an individual gaming machine may determine when one or more progressive award wins are triggered. In another embodiment, an individual gaming machine may determine when at least one progressive award win is triggered and the central controller determines when at least one progressive award win is triggered.

In one embodiment, one or more of the progressive awards are each funded via a side bet or side wager. In this embodiment, a player must place or wager a side bet to be eligible to win the progressive award associated with the side bet. In one embodiment, the player must place the maximum bet and the side bet to be eligible to win one of the progressive awards. In another embodiment, if the player places or wagers the required side bet, the player may wager at any credit amount on any payline (i.e., the player need not place the maximum bet and the side bet to be eligible to win one of the progressive awards). In one such embodiment, the greater the player's wager (in addition to the placed side bet), the greater the odds or probability that the player will win one of the progressive awards. It should be appreciated that one or more of the progressive awards may each be funded, at least in part, based on the wagers placed on the primary games of the gaming machines in the gaming system, via a gaming establishment or via any suitable manner. In one such embodiment, one or more progressive awards are funded, at least partially, via an amount provided by one or more marketing and/or advertising departments, such as a casino's marketing department.

In another embodiment, one or more of the progressive awards are partially funded via a side-bet or side-wager which the player may make (and which may be tracked via a side-bet meter). In one embodiment, one or more of the progressive awards are funded based on player's wagers as described above as well as any side-bets or side-wagers placed.

In one alternative embodiment, a minimum wager level is required for a gaming machine to qualify to be selected to obtain one of the progressive awards. In one embodiment, this minimum wager level is the maximum wager level for the primary game in the gaming machine. In another embodiment, this minimum wager level is placing a wager on all available paylines in a slot primary game or alternatively placing a wager on all available poker hands in a multi-hand poker primary game. In another embodiment, no minimum wager level is required for a gaming machine to qualify to be selected to obtain one of the progressive awards.

In one embodiment of the gaming system disclosed herein, one or more bonus or designated awards, such as the progressive awards, are provided to the players of the linked gaming machines in an apparently random fashion. In one such embodiment, the gaming machines do not provide any apparent reasons to the players for obtaining such awards. In this embodiment, the awards are not triggered by an event in or based specifically on any of the plays of any primary game or on any of the plays of any secondary game of the gaming machines in the system. That is, the gaming machines may simply provide the awards to the players without any explanation or alternatively with simple explanations such as “You Have Won a Mystery Bonus Award of $______.”

In one embodiment, the gaming machines of the gaming system are operable to provide multiple designated awards to multiple players at the multiple linked gaming machines at the same time or substantially the same time. Alternatively, the gaming machines of the gaming system are operable to provide multiple designated awards to multiple players at the multiple linked gaming machines in an overlapping or sequential manner.

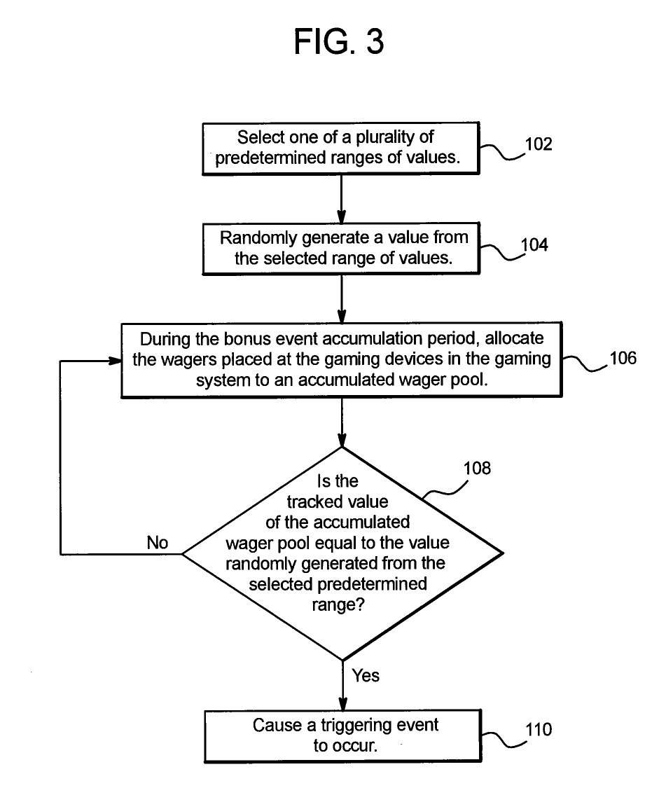

In another embodiment, the gaming system includes a plurality of predetermined ranges of wager amounts or values. In this embodiment, upon the initiation or beginning of a bonus event accumulation period, the central controller or gaming device processor selects one of the plurality of predetermined ranges as seen in block 102 of FIG. 3. From this selected predetermined range of wager amounts or values, the central controller or gaming device processor randomly generates a wager amount or value as indicated in block 104. For example, if a gaming system designer or operator wants a triggering event to occur every 10,000 credits wagered on average, the gaming system designer sets a first predetermined range from 1 to 10,000; sets a second predetermined range from 1 to 20,000; and sets a third predetermined range from 1 to 30,000.

In one such example, the central controller selects the second predetermined range with values from 1 to 20,000 and subsequently randomly selects the value of 17,320 from the selected second predetermined range. It should be appreciated that in this example, if each set range has an equal probability of being selected and each integer in each range has an equal probability of being selected, then on average, the triggering event will occur once every 10,000 credits wagered.

It should be appreciated that in these embodiments, the size of the predetermined range determines the frequency which a triggering event will occur and the sizes of the progressive awards. Thus, if a gaming system operator wants larger progressive awards, the gaming system operator will include larger predetermined ranges. That is, the greater the predetermined range, the greater, on average, the randomly generated number from the predetermined range and thus the greater amount of time for the progressive award to increment prior to the accumulated wager pool incrementing to the randomly generated value. It should be further appreciated that by selecting one range from a plurality of ranges and subsequently selecting one integer from the selected range, the gaming system disclosed herein provides an increased level of volatility for the frequency of triggering events occurring. That is, by using variable ranges to determine, at least in part, when a triggering event will occur, provides increased excitement and enjoyment to players who might otherwise become accustomed to triggering events occurs at relatively predictable intervals.

In another such example, the gaming system designer sets a first predetermined range from 1 to 10,000; sets a second predetermined range from 1 to 20,000; and sets a third predetermined range from 1 to 30,000, wherein each predetermined range has an equal 33.3% of being selected. In this example, the second predetermined range from 1 to 20,000 is broken down into two sub-ranges which each have an equal 50% probability of being selected, such that one sub-range of 1 to 10,000 has a 16.6% (i.e., 33.3% probability of the second predetermined range being selected×50% probability of this sub-range being selected) probability of being selected and another sub-range of 10,001 to 20,000 has a 16.6% (i.e., 33.3% probability of the second predetermined range being selected×50% probability of this sub-range being selected) probability of being selected. Moreover, the third predetermined range from 1 to 30,000 is broken down into three sub-ranges which each have an equal 33.3% probability of being selected, such that one sub-range of 1 to 10,000 has a 11.1% (i.e., 33.3% probability of the third predetermined range being selected×33.3% probability of this sub-range being selected) probability of being selected, another sub-range of 10,001 to 20,000 has a 11.1% (i.e., 33% probability of the third predetermined range being selected×33.3% probability of this sub-range being selected) probability of being selected and another sub-range of 20,001 to 30,000 has a 11.1% (i.e., 33.3% probability of the third predetermined range being selected×33.3% probability of this sub-range being selected) probability of being selected.

In this example, for the predetermined range of 1 to 10,000, there is a 61.1% probability of being selected (i.e., 33.3% probability associated with the first predetermined range being selected+16.6% probability associated with the sub-range of 1 to 10,000 for the second predetermined range being selected+11.1% probability associated with the sub-range of 1 to 10,000 for the third predetermined range being selected); for the range of 10,001 to 20,000 there is a 27.8% probability of being selected (i.e., 16.6% probability associated with the sub-range of 10,001 to 20,000 for the second predetermined range being selected+11.1% probability associated with the sub-range of 10,001 to 20,000 for the third predetermined range being selected); and for the range of 20,001 to 30,000 there is a 11.1% probability of being selected (i.e., 11.1% probability associated with the sub-range of 20,001 to 30,000 for the third predetermined range being selected). It should be appreciated that by assigning a 61.1% probability to the range of 1 to 10,000 being selected (which is associated with an average value of 5,000); a 27.8% probability to the range of 10,001 to 20,000 being selected (which is associated with an average value of 15,000); and a 11.1% probability to the range of 20,001 to 30,000 being selected (which is associated with an average value of 25,000), the gaming system designer provides that the bonus event will trigger, on average, every 10,000 coins-in the gaming system (i.e., 10,000=(0.61×5,000)+(0.278×15,000)+(0.111×25,000)). It should be further appreciated that in this example, the 61.1% probability that a value range of 1 to 10,000 will be selected provides for more frequent bonus triggers, while the 11.1% probability that a value range of 20,001 to 30,000 will be selected provides for larger progressive awards. Accordingly, in this example, the gaming system designer can set up the gaming system in a way that eliminates the predictability and varies the volatility of when the triggering events will occur while still maintaining that a trigger will occur, on average, a designated number of coins-in the gaming system.

In an alternative embodiment, upon the initiation or beginning of a bonus event accumulation period, the central controller or an individual gaming device processor randomly generates a wager amount or value from one predetermined range of values. For example, if a gaming system designer wants a triggering event to occur every 10,000 credits wagered on average, the gaming system designer sets the predetermined range from 1 to 20,000.

In one embodiment, a plurality of the value ranges each have a different number or quantity of values. In another embodiment, each of the value ranges has a different number or quantity of values. In another embodiment, a plurality of the value ranges each have the same number or quantity of values. In another embodiment, each of the value ranges has the same number or quantity of values. It should be appreciated that to account for certain value ranges have less quantity of values, certain value ranges are designed with larger quantity of values. In different embodiments, the quantity of values in at least one of the ranges is predetermined, randomly determined, determined based on one or more player's status (determined through a suitable player tracking system), determined based on a random determination by the central controller, determined based on a random determination at the gaming machine, determined based on one or more side wagers placed, determined based on the player's primary game wager, determined based on time (such as the time of day) or determined based on any other suitable method or criteria.

In one embodiment, each integer in at least one range has an equal probability of being randomly generated. In another embodiment, a plurality of integers in at least one range have equal probabilities of being randomly generated. In another embodiment, a plurality of integers in at least one range have different probabilities of being randomly generated. In another embodiment, each integer in at least one range has a different probability of being randomly generated. In different embodiments, the probability of being selected associated with each integer in at least one range is predetermined, randomly determined, determined based on one or more player's status (determined through a suitable player tracking system), weighted based on the quantity of values in the value range, determined based on a generated symbol or symbol combination, determined based on a random determination by the central controller, determined based on a random determination at the gaming machine, determined based on one or more side wagers placed, determined based on the player's primary game wager, determined based on time (such as the time of day) or determined based on any other suitable method or criteria.

In one embodiment, a plurality of the predetermined ranges each have an equal probability of being selected. In another embodiment, each of the predetermined ranges has an equal probability of being selected. In another embodiment, a plurality of the predetermined ranges each have a different probability of being selected. In another embodiment, each of the predetermined ranges has a different probability of being selected. In different embodiments, the probability of being selected associated with each predetermined range is predetermined, randomly determined, determined based on one or more player's status (determined through a suitable player tracking system), weighted based on the quantity of values in the value range, determined based on a generated symbol or symbol combination, determined based on a random determination by the central controller, determined based on a random determination at the gaming machine, determined based on one or more side wagers placed, determined based on the player's primary game wager, determined based on time (such as the time of day), determined based on the amount of coin-in accumulated in one or more pools, or determined based on any other suitable method or criteria.

In one such example of different ranges have different probabilities of being selected, the gaming system designer assigns a 45% probability of being selected with a first predetermined range of 1 to 10,000; assigns a 10% probability of being selected with a second predetermined range of 1 to 20,000; and assigns a 45% probability of being selected with a third predetermined range of 1 to 30,000. In this embodiment, as described above, the gaming system designer further assigns a 65% probably of being selected with a first sub-range of 1 to 10,000; a 20% probably of being selected with a second sub-range of 10,001 to 20,000 and a 15% probability of being selected with a third sub-range of 20,001 to 30,000. It should be appreciated that by assigning a 65% probability to the range of 1 to 10,000 being selected (which is associated with an average value of 5,000); a 20% probability to the range of 10,001 to 20,000 being selected (which is associated with an average value of 15,000); and a 15% probability to the range of 20,001 to 30,000 being selected (which is associated with an average value of 25,000), the gaming system designer provides that the bonus event will trigger, on average, every 10,000 coins-in the gaming system (i.e., 10,000=(0.65×5,000)+(0.20×15,000)+(0.15×25,000)). Thus, a gaming system designer can set up the gaming system with different ranges having different probabilities of being selected that eliminates the predictability and varies the volatility of when the triggering events will occur while still maintaining that a trigger will occur, on average, a designated number of coins-in the gaming system.

In one embodiment, during the bonus event accumulation period, the central controller (or one or more gaming device processors) monitors wagers or wager activity on the primary games of the gaming machines. In one such embodiment, the controller includes a total coin-in or wager meter, such as an accumulated wager pool, which tracks or allocates the total coin-in wagers placed on all of the primary games for all of the gaming machines in the gaming system. The controller tracks the total wagers for all of the gaming machines in the gaming system in any suitable compatible or comparable manner such as credits wagered (i.e., if all of the system gaming machines are of the same denomination) or monetary units (e.g., total dollars or other currency) wagered. Tracking in monetary units accounts for gaming machines having multi-denominations and/or for gaming machines of different denominations and/or gaming machines which accept different currencies. In such embodiments, the monetary unit can be in the lowest common denomination.

In one embodiment, the controller maintains the accumulated wager pool for one or more and preferably all of the gaming machines in the gaming system. In this embodiment, the accumulated wager pool includes at least the total coin-in or amounts wagered on the plays of the primary games of the gaming machines in the gaming system during the bonus event accumulation period, such as a progressive award event accumulation period. As indicated in block 106 of FIG. 3, in one embodiment, during the bonus event accumulation period, the central controller tracks or allocates the wagers placed (or a portion thereof) at the gaming devices in the gaming system to an accumulated wager pool.

In one embodiment, each bonus event or progressive award accumulation period starts at the occurrence of a first triggering or bonus event and ends at the occurrence of a second subsequent triggering or bonus event. For example, when a bonus event occurs, the accumulation of the monetary units for that bonus event simultaneously or substantially simultaneously ceases. In this example, any wagers made on the primary games of the gaming machines which subsequently occur are part of the next bonus event accumulation period and are accumulated for the next bonus event. It should be appreciated that the exact period of time of the bonus event accumulation period will vary based on many factors, such as the rate of coin-in or wagered monetary units, probability of triggering a bonus event and when the bonus events are triggered. It should also be appreciated that the bonus event accumulation session of the triggering for a bonus event for the gaming machines in the group can begin upon the initiation or enrollment of the gaming machines in the group.

In another embodiment, each bonus event or progressive award accumulation period starts at the issuance of a first bonus event and ends at the issuance of a second subsequent bonus event. For example, after a bonus event is determined to occur, a selected gaming machine will subsequently provide a progressive award to a player of that selected gaming machine. Accumulation of the monetary units for that bonus event ceases at the time that progressive award is provided to or received by the player. In this example, any wagers made on the primary games of the gaming machines which subsequently occur after issuance of that progressive award are for the next bonus event accumulation period and are accumulated in the accumulated wager pool for the next bonus event.

In one embodiment, at the start of each bonus event accumulation period, the accumulated wager pool will be set to zero. In an alternative embodiment, the accumulated wager pool does not need to be reset to zero. In one such embodiment, a percentage of the accumulated wager pool is employed for the bonus event and a percentage of the accumulated wager pool is not employed for the bonus event but is saved for a subsequent bonus event.

In one embodiment, the central controller determines if an amount or value tracked in the accumulated wager pool is equal to (or substantially equal to) the amount or value randomly generated from the selected predetermined range as indicated in diamond 108. In this embodiment, if the amount or value tracked in the accumulated wager pool is not equal to (or substantially equal to) the amount or value randomly generated from the selected predetermined range, the central controller continues allocating wagers placed to the accumulated wager pool for the bonus event accumulation period as described above and indicated in block 106. Using the example described above, if the central controller determines that the value tracking in the accumulated wager pool is less than 17,320, the central controller continues allocating wagers placed to the accumulated wager pool for the bonus event accumulation period.

If the amount or value tracked in the accumulated wager pool is equal to, substantially equal to (or greater than) the amount or value randomly generated from the selected predetermined range, a triggering event occurs as indicated in block 110. For example, if the central controller determines that the value tracking in the accumulated wager pool is equal to 17,320, the central controller causes a triggering event to occur.

In one embodiment, the central controller causes a triggering event to occur at the gaming device which places the wager that incremented the accumulated wager pool to (or above) the randomly generated value from the selected predetermined range. In another embodiment, the central controller causes a triggering event to occur at a plurality of the gaming devices in the gaming system. In different embodiments, which gaming device(s) the central controller causes a triggering event to occur at is predetermined, randomly determined, determined based on one or more player's status (determined through a suitable player tracking system), determined based on a generated symbol or symbol combination, determined based on a random determination by the central controller, determined based on a random determination at the gaming machine, determined based on one or more side wagers placed, determined based on the player's primary game wager, determined based on time (such as the time of day), or determined based on any other suitable method or criteria.

In one embodiment, upon an occurrence of the triggering event, a designated or bonus award, such as a progressive award, is provided to a player. In different embodiments, if the gaming system includes more than one designated award to provide to the player upon an occurrence of a triggering event, the selection of which designated award(s) to provide to the player is predetermined, randomly determined, determined based on one or more player's status (determined through a suitable player tracking system), determined based on a generated symbol or symbol combination, determined based on a random determination by the central controller, determined based on a random determination at the gaming machine, determined based on one or more side wagers placed, determined based on the player's primary game wager, determined based on time (such as the time of day), or determined based on any other suitable method or criteria.

In another embodiment, upon an occurrence of the triggering event, the central controller or gaming device processor enables a player to play one or more secondary or bonus games. In this embodiment, based on one or more independent determinations in the secondary or bonus games, one or more progressive awards in a multi-level progressive award configuration are provided to the player. That is, which progressive award from the multi-level progressive award configuration is provided to the player is determined independently from the determination that the accumulated wager pool is equal to (or substantially equal to) the value randomly generated from the selected predetermined range. In this embodiment, a player is provided a chance to move up one or more progressive award levels of an MLP, wherein winning any progressive award levels is based on the outcome of the secondary game. In another embodiment, one or more of the progressive award levels are each associated with a plurality of value ranges as described above. In this embodiment, different progressive award levels are associated with different value ranges, such that a lower level progressive award level is associated with a first plurality of lower value ranges and a higher level progressive award level is associated with a different, second plurality of higher value ranges. In this embodiment, which progressive award(s) are provided to the player are based on which progressive awards increment to a randomly selected value from a randomly selected value range.

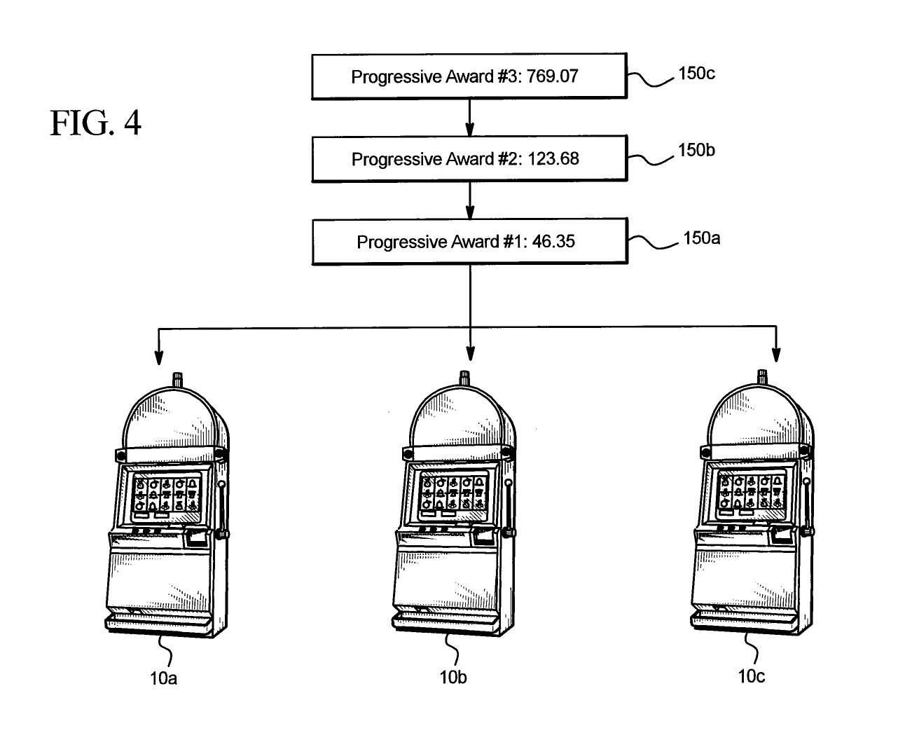

For example, as seen in FIG. 4, if the gaming system maintains a first progressive award 150a (valued at $46.35 at a first point in time), a second progressive award 150b (valued at $123.68 at a first point in time) and a third progressive award 150c (valued at $769.07 at a first point in time) in a multi-level progressive award configuration, the central controller enables the player at one of the gaming devices in the gaming system to play a bonus or secondary game to determine which of the progressive awards will be provided to the player. It should be appreciated that unlike existing accumulated value progressive awards (wherein each individual accumulated value progressive award is associated with a progressive award hit value and the progressive award is provided to a player if that progressive award increments to its respective progressive award hit value), in the gaming system disclosed herein, if the accumulated wager pool increments to the randomly generated value, which progressive award to provide to the player is determined based on one or more independent subsequent determinations.

In different embodiments, the progressive award from the multi-level progressive award configuration that is provided to the player is predetermined, randomly determined, determined based on one or more player's status (determined through a suitable player tracking system), determined based on a generated symbol or symbol combination, determined based on a random determination by the central controller, determined based on a random determination at the gaming machine, determined based on one or more side wagers placed, determined based on the player's primary game wager, determined based on time (such as the time of day), or determined based on any other suitable method or criteria. In different embodiments, the secondary game may be any suitable type of game including, but not limited to, reel/slot games, card games (e.g., poker, blackjack), lottery games, selection games, offer and acceptance games, wheel games, dice games, free spin games, competition games, skill games or perceived skill games. In one embodiment, the secondary game includes one or more rounds of game play.

As mentioned above, by selecting one range from a plurality of ranges and subsequently selecting one integer from the selected range, the gaming system disclosed herein provides an increased level of volatility for the frequency of triggering events occurring. Such volatility provides increased excitement and enjoyment to players who might otherwise become accustomed to triggering events occurs at relatively predictable intervals. For example, if after a first triggering event occurs (when an accumulated wager pool incremented to a first value of 430,479 randomly selected from a first selected value range of 1 to 500,000), a second value of 384 is randomly selected from a second randomly selected value range of 1 to 500, then as the accumulated wager pool will increment to the second value of 384 substantially quicker than the accumulated wager pool incremented to 430,479, a second triggering event will occur substantially quicker than the first triggering event occurred. That is, by sequentially selecting different ranges with different quantities of values in each range, the gaming system disclosed herein increases the volatility of different triggering events occurring and thus provides a gaming system with varying volatility.

In another embodiment, the gaming system disclosed herein includes a plurality of predetermined ranges of amounts or values, such as award values. In this embodiment, upon the initiation or beginning of a bonus event accumulation period, the central controller or gaming device processor selects one of the plurality of predetermined ranges. From this selected predetermined range of amounts or values, the central controller or gaming device processor randomly generates an amount or value. In one such embodiment, during the bonus event accumulation period, the central controller increments one or more progressive awards or progressive award pools based on a portion of the wagers placed at the gaming devices in the gaming system. In another such embodiment, the central controller increments one or more designated pools based on any suitable incrementor. In these embodiments, the central controller determines if the current value of the progressive award (or suitable designated pool) is equal to (or substantially equal to) the value randomly generated from the selected predetermined range. If the current value of the progressive award (or suitable designated pool) is not equal to (or substantially equal to) the value randomly generated from the selected predetermined range, the central controller continues incrementing the progressive award (or suitable designated pool). If the value of the progressive award (or suitable designated pool) is equal to, substantially equal to (or greater than) the value randomly generated from the selected predetermined range, a triggering event occurs and the gaming system proceeds as described above.

In another embodiment, the gaming system includes a plurality of different time ranges of when a triggering event for one or more of the progressive awards will occur. In this embodiment, upon the initiation or beginning of a bonus event accumulation period, the central controller or gaming device processor selects one of the plurality of time ranges. From this selected time range, the central controller or gaming device processor randomly generates a designated time. In one such embodiment, at a suitable time interval, the central controller increments a pool which tracks an amount of time elapsed from a designated event, such as when the last progressive award was provided to a player. In this embodiment, the central controller determines if the current time of the time based pool is equal to (or substantially equal to) the designated time randomly generated from the selected time range. If the current time of the time based pool is not equal to (or substantially equal to) the designated time randomly generated from the selected time range, the central controller continues incrementing the time based pool. If the current time of the time based pool is equal to, substantially equal to (or greater than) the designated time randomly generated from the selected time range, a triggering event occurs and the gaming system proceeds as described above.

In an alternative embodiment, the determination of when to cause a triggering event is applicable for an individual gaming device. In this embodiment, every gaming machine of the gaming system has a separate coin-in or wager meter, such a gaming device accumulated wager pool, for the bonus event accumulation period. As described above, when the gaming device accumulated wager pool associated with a designated gaming device increments to a randomly selected value from an applicable range of values, a triggering event occurs. In another alternative embodiment, the determination of when to cause a triggering event is applicable for a plurality of, but not all of the gaming devices in the gaming system.

In one alternative embodiment, one or more of the progressive awards maintained by the gaming system are associated with an accumulated wager pool incrementing to a value randomly selected from an applicable predetermined value range and a generation of an outcome in the primary game. In one embodiment, the determination of when to provide such a progressive award is symbol driven based on the generation of one or more designated symbols or symbol combinations. In one embodiment, the designated symbols or symbol combinations have a specific probability and will be chosen by the game designer to create an equal chance for all player's who are linked into the system. This progressive award can grow to very large amounts because a game designer can set this winning symbol combination at a very small probability.

In another alternative embodiment, the gaming system determines when to provide one or more of the progressive awards to one or more players based on an accumulated wager pool incrementing to a value randomly selected from an applicable predetermined value range along with such factors as when a designated amount of wagers or type of wagers are placed at one or more of the gaming devices of the gaming system. That is, these accumulated value progressive awards or N^{th} coin progressive awards are not symbol-driven, but rather are driven by an amount of wagers placed or a suitable coin-in amount. In one embodiment, each progressive award is associated with a range of values, wherein each progressive award will be provided to a player of a gaming device in the gaming system when the progressive award increments to a progressive award hit value within the range of values associated with that progressive award and the accumulated wager pool increments to the value randomly selected from the applicable predetermined value range.

In another alternative embodiment, a triggering event for one or more of the progressive awards occurs based on a predefined variable reaching a defined parameter threshold and an accumulated wager pool incrementing to a value randomly selected from an applicable predetermined value range. For example, a progressive award triggering event occurs when the 500^{th} different player has played a gaming machine associated with one of the progressive awards (ascertained from a player tracking system) and the accumulated wager pool increments to the value randomly selected from the applicable predetermined value range. In different embodiments, the predefined parameter thresholds include a length of time, a length of time after a certain dollar amount is hit, a wager level threshold for a specific machine (which gaming device is the first to contribute $250,000), a number of gaming machines active, or any other parameter that defines a suitable threshold.

In another alternative embodiment, a triggering event for one or more of the progressive awards occurs based on time and an accumulated wager pool incrementing to a value randomly selected from an applicable predetermined value range. In this embodiment, a time is set for when a progressive triggering event will occur. In one embodiment, such a set time is based on historic data. In one embodiment, a suitable algorithm is implemented to determine the player who wagered at or closest to this time with tie-breaking based on any number of factors (e.g., player tracking history, amount of or recent wagers placed). In this embodiment, a triggering event occurs and a progressive award is provided to the player who the algorithm determined wagered closest to when the progressive award is triggered if the accumulated wager pool is at least equal to the value randomly selected from the applicable predetermined value range. In another embodiment, one of the player who wagered during a designated time period is randomly selected and the progressive award is provided to the selected player.

In another embodiment, a triggering event for one or more of the progressive awards occurs based upon gaming system operator defined player eligibility parameters stored on a player tracking system (such as via a player tracking card or other suitable manner) and an accumulated wager pool incrementing to a value randomly selected from an applicable predetermined value range. For example, a gaming system operator may choose to only enable players of the highest player tracking status to be eligible for a progressive award. In this embodiment, the parameters for eligibility are defined by the gaming system operator based on any suitable criterion. In one embodiment, the central controller/gaming device processor recognizes the player's identification (via the player tracking system) when the player inserts their player tracking card in the gaming machine. The central server/gaming device processor determines the player tracking level of the player and if the current player tracking level defined by the gaming system operator is eligible for the progressive award. In one embodiment, the gaming system operator defines minimum bet levels required for the progressive award based on the player's card level. In this embodiment, different bet amounts are required to be eligible to receive different progressive award levels. In another embodiment, as described above, different side bets or side-wager amounts are required to be eligible to receive different progressive award levels. Once the central controller/gaming device processor determines which players are eligible, any suitable method for awarding the progressive award may be employed.

Another embodiment for determining the winner of one or more of the progressive awards includes a system determination, wherein the progressive award is provided due to a random selection by the central controller and an accumulated wager pool incrementing to a value randomly selected from an applicable predetermined value range. In one embodiment, the central controller tracks all active gaming machines and the wagers they placed. Each gaming machine has its own entry defining its state as either active or inactive and also defining the values of the wagers from that gaming machine. In one embodiment, active status means that the gaming machine is being actively played by a player and enrolled/inactive status means that the gaming machine is not being actively played by a player. The active status requirements can be based on any suitable number of satisfied criteria or defined in any suitable manner by the implementer of the gaming system. For instance, a play of or wager on the primary game of the gaming machine within a predetermined period of time may be part of the determination of whether that gaming machine is in the active status. Other factors such as: (a) the amount of time between each play of or wager on the primary game of the gaming machine; (b) the amount being wagered on the primary game(s); and (c) the number of plays within a period of time, may also or alternatively be part of the determination of whether a gaming machine is in the active status. On the other hand, inactive status means that the gaming machine is one of the gaming machines in the gaming system, but is not in the active status (i.e., not being actively played by a player according to one or more of the predetermined criteria).

In one such embodiment, based on the gaming machine's state as well as one or more wager pools associated with the gaming machine, the central controller determines which of these gaming machines receives any of the progressive awards. In one embodiment, the gaming machine which has been classified as active the longest since the last triggering event is provided at least one progressive award (and is provided a chance at winning any additional progressive awards in a secondary game). In another embodiment, the determination of the winner of one or more of the progressive awards is based on the relative proportion of gaming/wagering activity at each gaming device in the gaming system. In this embodiment, the player who consistently places a higher wager is more likely to receive one of the progressive awards than a player who consistently places a minimum wager.

### Information Provided to Player

As indicated above, the progressive awards may be provided to the players of the gaming machines with or without explanation or information provided to the player, or alternatively information can be displayed to the player. In one embodiment, suitable information about the progressive awards can be provided to the players through one or more displays on the gaming machines or additional information displays positioned near the gaming machines, such as above a bank of system gaming machines. In one embodiment, a metering and/or information display device may be used to display information regarding the progressive awards. This information can be used to entertain the player or inform the player that a progressive award triggering event has occurred or will occur. Examples of such information are:

(1) that a progressive award triggering event has occurred;

(2) that a progressive award triggering event will shortly occur (i.e., foreshadowing the providing of a progressive award);

(3) that one or more progressive awards have been provided to one or more players of the system gaming machines;

(4) which gaming machines have won the progressive awards;

(5) the amount of the progressive awards won;

(6) the highest progressive award won;

(7) the lowest progressive award won;

(8) the average progressive award won;

(9) number of games played/total time since the last progressive award was won;

(10) the number of progressive awards won in a designated time period;

(11) the upper limit or range which one or more progressive awards can increment to; and

(12) an average amount of time between each progressive award being won.

### It should be appreciated that such information can be provided to the players through any suitable audio, audio-visual or visual devices.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gaming system comprising:
a controller;
a plurality of gaming machines operable to communicate with the controller, each gaming machine including a primary game operable upon a wager placed by a player;
an accumulated wager pool maintained by the controller;
a plurality of progressive awards maintained by the controller; and
a plurality of different value ranges, wherein a plurality of the value ranges each include a range of different values;
wherein said controller is programmed to:
(a) select one of the plurality of value ranges;
(b) randomly select one of the values from the selected value range;
(c) during a bonus event accumulation period, increment said accumulated wager pool based on at least a portion of the wagers placed by the players at the gaming machines; and
(d) if the accumulated wager pool increments to the randomly selected value, cause a bonus event to occur;
wherein at least one of said progressive awards may be provided to one of the players of one of the gaming machines in said bonus event, wherein if one of said progressive awards is provided to one of the players, which progressive award that is provided is based on at least one determination independent of the accumulated wager pool incrementing to the randomly selected value.

2. The gaming system of claim 1, wherein the bonus event accumulation period begins at the occurrence of a previous triggering event and ends at the occurrence of the triggering event.

3. The gaming system of claim 1, wherein the bonus event accumulation period begins at the issuance of a previous progressive award and ends at the issuance of said progressive award.

4. The gaming system of claim 1, wherein if one of said progressive awards is provided to one of the players, the bonus event includes a secondary game, wherein a play of the secondary game determines which progressive award is provided.

5. The gaming system of claim 1, wherein said controller is programmed to increment said accumulated wager pool during the bonus event accumulation period based on the wagers placed by the players at the gaming machines.

6. The gaming system of claim 1, wherein said controller is programmed to randomly select one of the plurality of value ranges.

7. The gaming system of claim 1, wherein each of the values in a first one of the value ranges are different than each of the values in a second one of the value ranges.

8. A gaming system comprising:
a controller;
a plurality of gaming machines operable to communicate with the controller, each gaming machine including a primary game operable upon a wager placed by a player;
an accumulated pool maintained by the controller;
a plurality of progressive awards maintained by the controller; and
a plurality of different value ranges, wherein a plurality of the value ranges each include a range of different values;
wherein said controller is programmed to:
(a) select one of the plurality of value ranges;
(b) randomly select one of the values from the selected value range;
(c) during a bonus event accumulation period, increment said accumulated pool; and
(d) if the accumulated pool increments to the randomly selected value, cause a bonus event to occur;
wherein at least one of said progressive awards may be provided to one of the players of one of the gaming machines in said bonus event, wherein if one of said progressive awards is provided to one of the players, which progressive award that is provided is based on at least one determination independent of the accumulated pool incrementing to the randomly selected value.

9. The gaming system of claim 8, wherein the accumulated pool is one of the progressive awards.

10. The gaming system of claim 9, wherein the controller is programmed to increment said accumulated pool based on at least a portion of the wagers placed by the players at the gaming machines.

11. The gaming system of claim 8, wherein the controller is programmed to increment said accumulated pool based on time.

12. The gaming system of claim 8, wherein the bonus event accumulation period begins at the occurrence of a previous triggering event and ends at the occurrence of the triggering event.

13. The gaming system of claim 8, wherein the bonus event accumulation period begins at the issuance of a previous progressive award and ends at the issuance of said progressive award.

14. The gaming system of claim 8, wherein if one of said progressive awards is provided to one of the players, the bonus event includes a secondary game, wherein a play of the secondary game determines which progressive award is provided.

15. The gaming system of claim 8, wherein said controller is programmed to randomly select one of the plurality of value ranges.

16. The gaming system of claim 8, wherein each of the values in a first one of the value ranges are different than each of the values in a second one of the value ranges.

17. A method of operating a gaming system, said gaming system including a controller in communication with a plurality of gaming machines wherein each gaming machine includes a primary game operable upon a wager placed by a player, said method comprising:
(a) maintaining a plurality of progressive awards;
(b) selecting one of a plurality of value ranges, wherein a plurality of the value ranges each include a range of different values;
(c) randomly selecting one of the values from the selected value range;
(d) during a bonus event accumulation period, incrementing an accumulated wager pool based on at least a portion of the wagers placed by the players at the gaming machines;
(e) if the accumulated wager pool increments to the randomly selected value, causing a bonus event to occur; and
(f) determining whether to provide at least one of said progressive awards to one of the players of one of the gaming machines in the bonus event, wherein if the determination is to provide one of said progressive awards, which progressive award that is provided is determined independent of the accumulated wager pool incrementing to the randomly selected value.

18. The method of claim 17, wherein the bonus event accumulation period begins at the occurrence of a previous triggering event and ends at the occurrence of the triggering event.

19. The method of claim 17, wherein the bonus event accumulation period begins at the issuance of a previous progressive award and ends at the issuance of said progressive award.

20. The method of claim 17, wherein if the determination is to provide one of said progressive awards, the bonus event includes a secondary game, wherein a play of the secondary game determines which progressive award is provided.

21. The method of claim 17, which includes incrementing said accumulated wager pool during the bonus event accumulation period based on the wagers placed by the players at the gaming machines.

22. The method of claim 17, which includes randomly selecting one of the plurality of value ranges.

23. The method of claim 17, wherein each of the values in a first one of the value ranges are different than each of the values in a second one of the value ranges.

24. The method of claim 17, which is provided through a data network.

25. The method of claim 24, wherein the data network is an internet.

26. A method of operating a gaming system, said gaming system including a controller in communication with a plurality of gaming machines wherein each gaming machine includes a primary game operable upon a wager placed by a player, said method comprising:
(a) maintaining a plurality of progressive awards;
(b) selecting one of a plurality of value ranges, wherein a plurality of the value ranges each include a range of different values;
(c) randomly selecting one of the values from the selected value range;
(d) during a bonus event accumulation period, incrementing an accumulated pool;
(e) if the accumulated pool increments to the randomly selected value, causing a bonus event to occur; and
(f) determining whether to provide at least one of said progressive awards to one of the players of one of the gaming machines in the bonus event, wherein if the determination is to provide one of said progressive awards, which progressive award that is provided is determined independent of the accumulated wager pool incrementing to the randomly selected value

27. The method of claim 26, wherein the accumulated pool is one of the progressive awards.

28. The method of claim 27, which includes incrementing said accumulated pool based on at least a portion of the wagers placed by the players at the gaming machines.

29. The method of claim 26, which includes incrementing said accumulated pool based on time.

30. The method of claim 26, wherein the bonus event accumulation period begins at the occurrence of a previous triggering event and ends at the occurrence of the triggering event.

31. The method of claim 26, wherein the bonus event accumulation period begins at the issuance of a previous progressive award and ends at the issuance of said progressive award.

32. The method of claim 26, wherein if the determination is to provide one of said progressive awards, the bonus event includes a secondary game, wherein a play of the secondary game determines which progressive award is provided.

33. The method of claim 26, which includes randomly selecting one of the plurality of value ranges.

34. The method of claim 26, wherein each of the values in a first one of the value ranges are different than each of the values in a second one of the value ranges.

35. The method of claim 26, which is provided through a data network.

36. The method of claim 35, wherein the data network is an internet.
